(19) United States
(12) Patent Application Publication
(10) Pub. No.: US 2024/0415125 A1
(43) Pub. Date: Dec. 19, 2024

(54) INSECT-REPELLENT COMPOSITIONS AND USES THEREOF

(71) Applicant: The United States of America, as represented by the Secretary of Agriculture, Washington, DC (US)

(72) Inventors: DANIEL L. KLINE, GAINESVILLE, FL (US); ADAM R. BOWMAN, HIGH SPRINGS, FL (US); CHRISTOPHER BATICH, GAINESVILLE, FL (US); NAGARAJAN RAMASAMY RAJAGOPAL, GAINESVILLE, FL (US)

(21) Appl. No.: 18/742,095

(22) Filed: Jun. 13, 2024

Related U.S. Application Data
(60) Provisional application No. 63/508,563, filed on Jun. 16, 2023.

(51) Int. Cl. A01N 53/00; A01N 31/04; A01P 7/04; A01P 17/00

(52) U.S. Cl. CPC A01N 53/00; A01N 31/04; A01P 7/04; A01P 17/00

(57) ABSTRACT

The disclosure relates to spatial repellent azeotrope-like mixtures, and the use of such azeotrope-like mixtures in controlled release passive devices (CRPD) to repel, knock-down, and/or kill arthropod pests.

### CROSS-REFERENCE TO RELATED APPLICATIONS

This application claims priority benefit U.S. Patent Application 63/508,563, filed on 16 Jun. 2023. The contents of this patent application are hereby expressly incorporated by reference in their entirety.

### STATEMENT OF FEDERALLY FUNDED RESEARCH

The work described herein was performed with U.S. Government support from the United States Department of Agriculture (USDA) Federal Grant No. 59-6036-9-001. The government has certain rights in this work.

### FIELD OF THE INVENTION

The present disclosure relates to spatial repellent azeotrope-like compositions and their use in controlled release passive devices to repel, knock-down, and/or kill arthropod pests.

### BACKGROUND OF THE INVENTION

Arthropod-borne diseases, such as malaria, dengue, scrub typhus, and leishmaniasis, continue to pose a significant threat to humans. Biting arthropods not only transmit disease, but as persistent pests they can inflict painful and distracting bites that may lead to secondary infections, dermatitis, or allergic reactions. Traditional methods used to minimize exposure to biting arthropods include application of residual insecticides on tents and buildings, use of barrier sprays, ultralow volume (ULV) or thermal fogging applications of insecticides, and use of personal protective measures (PPM), such as the application of topical insect repellent on exposed skin, wearing permethrin-treated uniforms, and the use of insecticide-treated bednets.

In instances of limited impact from these methods, failure has been attributed to unavailability, non-compliance, improper use, and ineffectiveness of some of the products. The use of area-wide or spatial repellents has been suggested as a possible alternative. Spatial repellents have been shown to achieve long-term area protection of humans from mosquito bites.

U.S. Pat. No. 10,092,003 teaches insect control devices comprising glass fibers, and optionally a binder, coated with a dry solid insect control composition comprising a pyrethroid. U.S. Pat. No. 10,856,540 discloses insect control devices comprising glass fibers or a non-absorbent material in a web, optionally comprising a binder and coated with an insect control composition.

US patent application publication No. 20200390094 discloses fabrics having an insect repellent such as an essential oil and an insecticide such as permethrin, and are said to provide improved insect-resistance efficacy when compared with fabrics having only a repellent or an insecticide alone. US patent application publication No. 20190254283 discloses insect repellent compositions that include an alcohol solvent and an ethoxylated oil mixed with an insecticidal pyrethroid of at least 25% of the composition.

US patent application publication No. 20180010078 and No. 20160108345 disclose a detergent composition comprising permethrin to launder clothing or other personal fabrics.

U.S. Pat. Nos. 5,631,072 and 5,503,918 teaches placement of an insecticide such as permethrin in a fabric by impregnation with polymeric binders and a cross-linking agent; or by surface coating with a polymeric binder and a thickening agent to improve the efficacy as an insect repellent and retention of the permethrin in the fabric as an effective insecticide through successive washings of the garments.

U.S. Pat. Nos. 5,252,387 and 5,198,287 discloses an insect repellent fabric that has a coating containing permethrin and a plasticizer, and having a barrier that covers the coating to protect the permethrin from degradation by ultraviolet light and oxygen. The barrier may be an acrylic coating or film, aluminum foil, a urethane coating or film, or an outer fabric barrier such as an awning or a tent fly.

U.S. Pat. No. 5,198,287 A tent fabric with a water repellent and flame retardant coating that includes the insecticide permethrin with an effective life of more than six months.

U.S. Pat. No. 5,089,298 relates to the impregnation of clothing with amylopectin fabric wrinkle inhibitor in combination with permethrin insect/arthropod repellent.

Commercially available devices used for insect repellency include Dr. Talbot's mosquito clips containing citronella and lemongrass; iKit guard buttons containing citronella; Bite shield clip-ons containing geraniol MM30; Off! Clip on mosquito repellent containing metofluthrin; RIDDEX mosquito repellent clips containing citronella and grapeseed oil; SUAVEC mosquito repellent devices containing a blend of essential oils.

Thus, novel spatial repellents capable of long-term protection, and their use in controlled release passive devices (CRPD) that require minimal involvement of the human are needed.

### SUMMARY OF THE INVENTION

Provided herein are spatial repellent azeotrope-like mixtures, and controlled release passive devices (CRPD) containing such mixtures to repel, knock-down, and/or kill arthropod pests.

In an embodiment, the disclosure relates to a spatial repellent azeotrope-like mixture comprising a pyrethroid. In some embodiments of the disclosure, the pyrethroid is allethrin, bioallethrin, bioresmethrin, cyfluthrin, cypermethrin, cyphenothrin, d-phenothrin, deltamethrin, fenvalerate, fluvalinate, metofluthrin, permethrin, phenothrin, resmethrin, tefluthrin, tetramethrin, transfluthrin, or a mixture thereof. In some embodiments of the disclosure, the azeotrope-like comprises benzyl alcohol, dimethylsulphoxide, ethyl acetate, butyl acetate, ethyl L-acetate, propylene carbonate, dowanol pm, cyclohexane, petroleum oil, or a mixture thereof.

In an embodiment, the disclosure relates to a controlled release passive device (CRPD) containing at least one spatial repellent azeotrope-like mixture comprising a pyrethroid to repel, knock-down, and/or kill arthropod pests. In some embodiments of the disclosure, the spatial repellent azeotrope-like mixture is present in the CRPD in an absorbent material. In some embodiments of the disclosure the absorbent material in which the spatial repellent azeotrope-like mixture is present in the CRPD is from plant source, animal source, or a combination thereof. In some embodiments of the disclosure, knocking down, repelling, and/or killing of the arthropod pests using the spatial repellent azeotrope-like mixture does not require, heat, movement, or an electrical stimulus.

### BRIEF DESCRIPTION OF THE DRAWINGS

FIG. 1 depicts a schematic diagram of a semi-field study enclosure.

FIG. 2 depicts a schematic diagram of the entrance to rear groupings of the bioassay traps used in statistical analysis of Aedes aegypti knockdown counts. Each filled dot represents a vertical grouping of three (3) bioassay traps.

FIG. 3A to 3D depict graphs of the knockdown/mortality curves for A. aegypti mosquitoes in bioassay cages in 24-hour periods. FIG. 3A shows the knockdown/mortality during the 24 hour increment 1. FIG. 3B shows the knockdown/mortality during the 24 hour increment 2. FIG. 3C shows the knockdown/mortality during the 24 hour increment 3. FIG. 3D shows the knockdown/mortality during the 24 hour increment 4. The Y Axis shows the number of knocked down mosquitoes. The X axis shows the exposure time in hours (h). Diamonds (present data from front traps, squares (D) present data for middle traps, and triangles (A) present data for rear traps.

FIG. 4 depicts a graph of the knockdown/mortality of A. aegypti in the top, middle, and bottom bioassay cages in study increments one to four. Bars with diamond bricks present data for top cages, bars with vertical stripes present data for middle cages, and solid bars represent data for bottom cages.

FIG. 5A and FIG. 5B show images of exemplary controlled release passive devices (CRPD) containing repellent azeotrope-like mixtures attached to boots. FIG. 5A presents an image where the CRPDs are fastened to the boot shoelaces. FIG. 5B presents an image where the CRPDs are fastened to a different area of the boot.

FIG. 6A and FIG. 6B show images of exemplary CRPDs fastened to a hat. FIG. 6A presents a view from above. FIG. 6B presents a view from the side of the hat.

### DETAILED DESCRIPTION

The disclosure relates to azeotrope-like mixtures of spatial repellents such as a pyrethroids and a solvent, and the use of such azeotrope-like mixtures in controlled release passive devices (CRPD) to repel, knock-down, and/or kill arthropod pests.

The disclosure relates to spatial repellent azeotrope-like mixtures, and the use of such azeotrope-like mixtures in controlled release passive devices (CRPD) to repel, knock-down, and/or kill arthropod pests for extended periods of time.

Repellents drive mosquitoes away from a treated space, toxicants kill mosquitoes and contact irritants cause agitation. Repellents can operate from a further distance than irritants and toxicants which rely on contact between the mosquito and a treated surface to function. Many compounds exhibit two or more modes of action, but they can be distinguished by the concentration or dose needed to achieve them. Spatial repellency occurs at low vapor phase concentration, contact irritancy requires higher doses, and killing requires absorption of still higher levels.

Pyrethroids are a group of man-made pesticides similar to the natural pesticide pyrethrum, which is produced by chrysanthemum flowers. Examples include allethrin, bioallethrin, bioresmethrin, cyfluthrin, cypermethrin, cyphenothrin, d-phenothrin, deltamethrin, fenvalerate, fluvalinate, metofluthrin, permethrin, phenothrin, resmethrin, tefluthrin, and tetramethrin.

An azeotrope-like is a mixture that exhibits the same concentration in the vapor phase as in the liquid phase. The instant disclosure refers to an azeotrope-like comprising a pyrethroid and a solvent. The solvent may be benzyl alcohol, dimethylsulphoxide, ethyl acetate, butyl acetate, ethyl L-acetate, propylene carbonate, dowanol pm, cyclohexane, geraniol, 1-octanol, petroleum oil.

Transfluthrin (ISO) is produced at a minimum purity of 96.5%, referring to a IR, transconfiguration. The cis/trans, S-isomers and 1R,cis-isomer are considered impurities. Transfluthrin is a white solid, with no characteristic odor (pure substance) or a toluene-like odor (technical substance). The relative density at 20° C. was determined to be 1.3856. Transfluthrin does not self-ignite. An exothermal decomposition was observed between 250° C. and 390° C. (breakdown products are unknown). Transfluthrin is not classified as flammable, auto-flammable, explosive, or oxidizing.

Spatial repellents have been shown to achieve long-term area protection of humans from mosquito bites. In the studies described herein effective protection was achieved by maintaining adequate levels of the active ingredient, Transfluthrin (TF), in the air. Disclosed herein are spatial repellent azeotrope-like mixtures, and controlled release passive devices (CRPD) comprising an absorbent material and such spatial repellent azeotrope-like mixtures. These CRPDs are surprisingly capable of repelling, knocking-down, and/or killing arthropod pests for at least 30 days. The spatial repellent azeotrope-like mixtures are capable of repelling, knocking-down, and/or killing arthropod pests for at least 4 weeks, 5 weeks, 6 weeks, 7 weeks, 8 weeks, 12 weeks, 16 weeks, or a portion thereof.

Using Transfluthrin (TF) in an azeotrope-like mixture, the novel controlled release passive devices (CRPDs) demonstrated efficacy in semi-field studies described herein. The knockdown rates of the caged mosquitoes were faster in the first 1-week study increment and were more uniform over subsequent study increments. Almost 100% knockdown of caged mosquitoes was achieved in 24 hours in all four study increments. The knockdowns were significantly faster and higher in the semi field study tent front closer to the CRPDs when compared to the effects at the rear end of the tent. This can be attributed to the fact that Transfluthrin is a heavier-than-air molecule and requires time to permeate all the way to the rear end of the tent. The recapture of free flying mosquitoes in the treated tent for all the four species showed an average repellency rate of 80% when compared to the control tent. This is evident from the data collected from the traps over the four weeks of testing. The mosquitoes which entered the tent and were captured in the tent were also completely knocked down. This is an added advantage as the mosquitoes that evade repellency and enter the tent are also rendered inactive, thereby preventing biting. The slow release of TF from the azeotrope-like solution enables the CRPDs to remain active and efficient for prolonged periods of time.

The spatial repellent azeotrope-like mixtures of the invention repel, knock-down, and/or kill arthropod pests inside a tent for at least about 30 days, from the entrance to the tent to the rear of the tent, a distance of about 6.6 m.

The azeotrope-like mixtures were impregnated in a fiber web and inserted in a device. The fiber web contains an absorbent material. For example, the fiber web may contain natural fibers or man-made fibers. Natural fibers are those found in nature and can be categorized by the source of their origin as from plant sources or animal sources. Examples of fibers from plant sources are cotton, ramie, linen, or mixtures thereof; examples of fibers from animal sources may be silk or wool. Manmade fibers may be from cellulosic sources, or chemical sources. Manmade fibers from cellulosic sources may be rayon, acetate, or triacetate; manmade fibers from chemical sources may be acrylic, modacrylic, nylon, olefin, polyester, rubber, or spandex. Fibers from mineral sources such as glass fibers and metallic fibers are not absorbent. Thus, the fibers from mineral sources are not useful to impregnate the spatial repellent azeotrope-like mixtures in the controlled release passive devices (CRPD) to repel, knock-down, and/or kill arthropod pests.

The device comprising the impregnated fiber web may be small such that it can be attached to a subject, or it may be larger. It is possible to locate larger, long and narrow, devices containing an azeotrope-like mixture of the invention on one or both sides of an entrance to to repel, knock-down, and/or kill arthropod pests. To protect an entrance, it is also possible to use several small devices containing an azeotrope-like mixture of the invention attached to a cord, a tape, a wire, or any other thin material, The small devices may be either touching each other or separated from each other and held in place by such a cord, tape, wire, or other thin material to repel, knock-down, and/or kill arthropod pests. These strings of small devices containing an azeotrope-like mixture of the invention may be located at entrances.

The shape and size of the device is such that the impregnated fiber web is located towards the outer layer of the device from where vapor is released. The controlled release passive devices (CRPDs) may contain a surface area that allows the azeotrope-like mixture to passively disseminate. The configuration of the CRPDs may depend on the application, but they are designed such that a user will not come in direct contact with the azeotrope-like mixture. The device may have different lumens such that the insect-repelling fiber is in one lumen, and a fragrance or other substance may be in a different lumen.

Small devices may be attached to a surface, or a subject by any means. The subject may be a human, a pet, or a horse. Small devices may be attached, for example, to a person's shoe, shoelace, hat, or article of clothing, to a pet leash, harness, or collar, or to a horse hood, socks, or leggings. The pet may be a dog, cat, rodent, or a reptile. Shoelaces may be impregnated with a spatial repellent azeotrope-like mixtures of the invention.

The devices are made of any material that does not react with the spatial repellent azeotrope-like mixture or its components. The devices may be made using a 3D printer. Materials commonly used in 3D printers are acrylonitrile butadiene styrene, acrylic styrene acrylonitrile, polypropylene, nylon, polylactic acid, high impact polystyrene, and polycarbonate. In an embodiment, the devices are made of polypropylene.

Prior to use, the devices may be covered with an appropriate material to avoid release of the spatial repellent azeotrope-like mixture vapor before it is needed. Covering may be made of a metal, a metal covered plastic, or the like.

As used herein, the term “azeotrope-like” refers to a mixture that has a higher or lower boiling point than either component of the mixture. A spatial repellent azeotrope-like mixture comprising a pyrethroid may be a “positive azeotrope-like” where the mixture has a lower boiling point than either component. In a positive azeotrope-like mixture the pyrethroid is released at a faster rate into the air compared to the pyrethroid not in a positive azeotrope-like mixture. A spatial repellent azeotrope-like mixture comprising a pyrethroid may be a “negative azeotrope-like” where the mixture has a higher boiling point than either component. In a negative azeotrope-like mixture the pyrethroid is less volatile, allowing for longer pyrethroid release times into the air compared to a pyrethroid not in a negative azeotrope-like mixture.

As used herein, the term “about” is defined as plus or minus ten percent of a recited value. For example, about 1.0 g means 0.9 g to 1.1 g and all values within that range, whether specifically stated or not.

As used herein, the term “attach” relates to fasten a device comprising a spatial repellent azeotrope-like mixture by tying, gluing, or inserting in a pocket or similar structure.

As used herein, the term “repel” refers to causing arthropod pests to make oriented movements away from a source comprising a spatial repellent azeotrope-like composition of the invention and may include inhibiting feeding, breeding, or ovipositing by such arthropod pests when such an azeotrope-like composition is present in a place where arthropod pests would, in the absence of the azeotrope-like composition, feed, breed, or oviposit. Thus the term “repel” also includes reducing the number of arthropod pests on a treated area or object when compared to the same area or object which is not treated with such an azeotrope-like composition.

Unless otherwise explained, all technical and scientific terms used herein have the same meaning as commonly understood by one of ordinary skill in the art to which this disclosure belongs. The singular terms “a”, “an”, and “the” include plural referents unless context clearly indicates otherwise. Similarly, the word “or” is intended to include “and” unless the context clearly indicate otherwise.

The amounts, percentages, and ranges disclosed herein are not meant to be limiting, and increments between the recited amounts, percentages, and ranges are specifically envisioned as part of the invention. All ranges and parameters disclosed herein are understood to encompass any and all subranges subsumed therein, and every number between the endpoints. For example, a stated range of “1 to 10” should be considered to include any and all subranges between (and inclusive of) the minimum value of 1 and the maximum value of 10 including all integer values and decimal values; that is, all subranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Embodiments of the present invention are shown and described herein. It will be obvious to those skilled in the art that such embodiments are provided by way of example only. Numerous variations, changes, and substitutions will occur to those skilled in the art without departing from the invention. Various alternatives to the embodiments of the invention described herein may be employed in practicing the invention. It is intended that the included claims define the scope of the invention and that methods and structures within the scope of these claims and their equivalents are covered thereby. All publications, patents, and patent applications mentioned in this specification are herein incorporated by reference to the same extent as if each individual publication, patent, or patent application was specifically and individually indicated to be incorporated by reference.

### EXAMPLES

Having now generally described this invention, the same will be better understood by reference to certain specific examples, which are included herein only to further illustrate the invention and are not intended to limit the scope of the invention as defined by the claims.

### Example 1

### Materials and Methods

The materials and methods used to determine the spatial repellency of pyrethroids azeotrope-like mixtures in controlled release passive devices (CRPD) to repel, knock-down, and/or kill arthropod pests are disclosed in this example.

### Semi-Field Study Site—

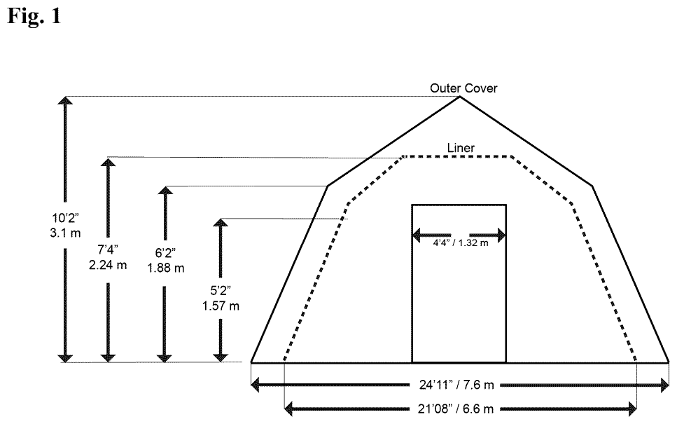

Semi-field studies were conducted at the US Department of Agriculture, Agricultural Research Service, Center for Medical, Agricultural, and Veterinary Entomology (USDA-ARS-CMAVE) in Gainesville, Florida, USA, in two outdoor screened enclosures (each 9.1×18.3×4.9 m high, pitched to 5.5 m with metal frames). The long axis of the enclosures was oriented north to south, and the enclosures were parallel to each other and 24 m apart. An entry door was on the southeast corner of each enclosure. Each enclosure contained a military tent (HDT Base X Model 305 Shelter, HDT Global, Solon, Ohio, USA) with a floor space of 5.5×7.6 m long, walls 2.24 m high and the roof pitched to 3.1 m high at the peak. A schematic diagram of a semi-field study enclosure is shown in FIG. 1. Tent was in the south end of the enclosures and tent openings were 1.22×1.91 m high and faced north. The treated tent was in the west enclosure and the control tent was in the cast enclosure.

### Mosquitoes and Bioassay Cages—

Mosquito strains used in these studies were from CMAVE colonies and included pyrethroid-susceptible Orlando strains of Aedes aegypti, Aedes taeniorhynchus, and Anopheles quadrimaculatus (all maintained since 1952), and a Gainesville 1996 pyrethroid-susceptible strain of Culex quinquefasciatus (Allan et al., 2005). All were maintained in the CMAVE insectaries using previously published procedures (Gerberg et al., 1994; Allan et al., 2005). Colonies were kept at room temperature (22.5° C.) or in an incubator (27° C.) with a photoperiod of 14:10 (L: D) hours, and ad libitum access to 10% sucrose-soaked cotton.

When caged mosquitoes were used to determine knockdown/mortality effects, they were housed in bioassay cages. These were made from cardboard rings (Multi Packaging Solutions, Chicago, Illinois, USA), and consisted of one wide inner ring (15.2 cm in diameter x 3.8 cm wide) and two narrower but slightly larger in diameter outer rings (15.9 cm in diameter x 1.6 cm wide) into which the inner ring would fit. A circle of tulle fabric cut slightly larger than the diameter of the wide inner ring was laid and centered across a wide ring placed on its side. An outer ring was slipped over the tulle and onto the inner ring holding the tulle tightly in place. The process was repeated for the opposite side of the inner ring. A 1.3-cm hole centered in the rim of the wide inner ring was used for placement of dental wicks or cotton saturated with sucrose solution as needed. The tulle fabric can be easily removed to put mosquitoes inside the cage. Twenty-five 5- to 6-day-old female Ae. aegypti mosquitoes were put into each cage after being knocked down in a cold room at 5° C. degrees for 10 minutes. Mosquitoes were allowed to fully recover before the bioassay cages were used in the tent studies.

In the first study increment to determine how free-flying mosquitoes would respond to the TF, 300 Ae. aegypti 5- to 8-day-old females were released in the screened enclosures containing the treated and untreated tents after the 4-h knockdown count (see below). In study increments 2-4 to determine if different mosquito species would respond differently to the TF, 5 to 8-day-old female mosquitoes, 300 each of Ae. aegypti, Ae. taeniorhynchus, An. quadrimaculatus, and Cx. quinquefasciatus, were released after the 4-h knockdown count (see below). Mosquitoes were released simultaneously in the opposite end of the screened enclosures from where the tents were placed.

### Controlled Release Passive Devices (CRPDs)—

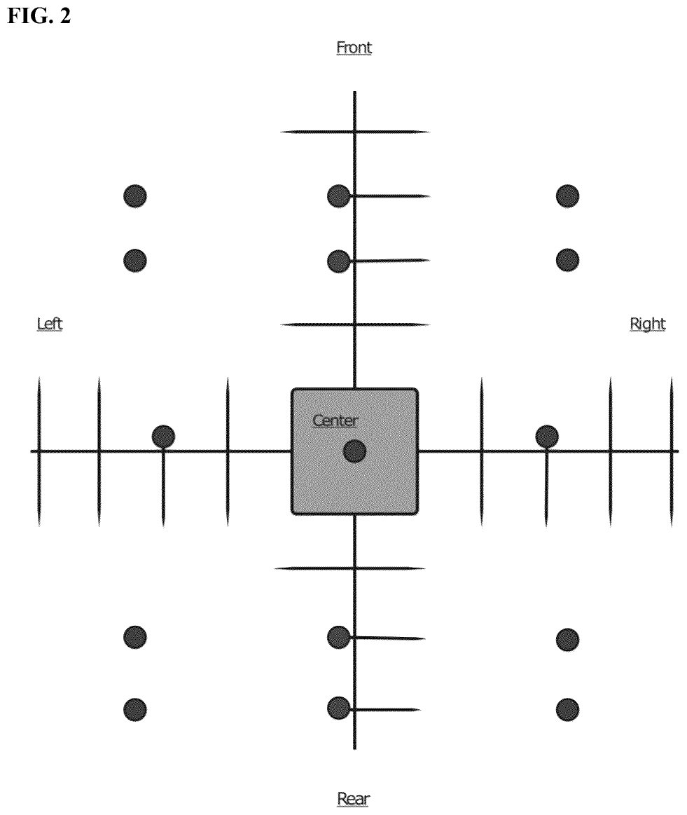

The CRPDs utilized in this study were multi-lumen devices constructed from different sizes of polypropylene drinking straws. The outer straw (Comfy Package, Brooklyn, New York, USA) has an 8-mm-diameter lumen which encloses two smaller straws (KCH Corporation, Brooklyn, New York, USA), each with 3-mm-diameter lumens. Cotton (0.5 g) was packed in the 8-mm lumen in the space not occupied by the two smaller 3-mm straws to contain and release the spatial repellent formulation. A diagrammatic schematic of a CRPD prepared with straws and used in this Example is shown in FIG. 2. The CRPDs used were 2.5-cm long and open at both the ends. CRPDs were attached to monofilament fishing line for ease of spacing and placement.

CRPDs were activated by saturating the cotton with 0.75 ml of 30% TF dissolved w/w in benzyl alcohol. The mixture of TF and benzyl alcohol form an azeotrope-like mixture and have the same composition in the vapor state as in the liquid state.

### Experimental Set-Up and Design—

The TF-activated CRPDs were suspended in six (6) parallel vertical rows at the top margin of the treated tent entrance. The rows, spaced 20 cm apart, were comprised of 10 CRPDs spaced 10 cm apart on monofilament fishing line. Rows of non-activated CRPDs were not placed at the entrance of the control tent because preliminary studies showed no change in mosquito entry into the tent with or without the presence of non-activated CRPDs.

Mosquitoes in bioassay cages were used to determine knockdown/mortality effects produced by the rows of CRPDs at the tent entrance. To enable placement of bioassay cages in a more-or-less 3-dimensional array inside the tents, a framework was made from ¾-inch polyvinyl chloride (PVC) pipe. Starting at the tent door, 7 vertical posts fastened onto 2-x 4-inch lumber were placed along the longitudinal center of the tent floor. Posts were spaced 1 m apart and the distance from post 7 to the rear wall of the tent was 1.5 m. A row of 6 posts was placed midway between and perpendicular to posts 4 and 5 with 3 posts on each side of the longitudinal row, all spaced 1 m apart. Horizontal lengths of PVC connected near the tops of the posts provided stability. Near the top of each post a pair of 43-cm PVC pipes in opposite sides of a tee connector was mounted perpendicular to the long axis of the row of posts. These formed T's and created stations from which to suspend the bioassay cages. By means of wiring in the roof of the tent, four additional remote stations were created on each side of the longitudinal row of posts. Remote stations were adjacent to and 1.5 m from posts 2, 3, 6, and 7. The 1 m² area between longitudinal posts 4 and 5 and perpendicular posts 3 and 4 was framed at ground level with 2×4-inch lumber which was then covered with a fitted piece of 0.5-in plywood to form a central platform.

In the treated tent, bioassay cages were suspended vertically with flexible 18-gauge steel wire (Hillman Group Inc., Cincinnati, Ohio, USA) from 15 stations as shown in the FIG. 2 schematic drawing, with 3 cages suspended on the same wire at 0.5, 1.0, and 1.5 m above ground at each station. These heights were equivalent to the height of a human's knees, waist, and shoulders, respectively. In the control tent two bioassay cages were hung at the tent entrance on the left and right, two in the rear on the left and right of post 6, and one over the central platform. Control cages were hung vertically only at the 1.5 m level.

If there was a concentration of TF at any location within the tent sufficient to cause knockdown of caged mosquitoes, then it was assumed that the level of TF should be detected by the free-flying mosquitoes and cause them to be repelled. Results from bioassay cages would thus provide an indication of the dispersion pattern of the TF. Because the main purpose of the caged insects was to determine knockdown effects, only one species, Ae. aegypti, was used in the bioassay cages. Knockdown was defined as when the mosquitoes are incapable of flight. Counts in control and treated tents were compared.

To monitor the potential of the CRPDs at the tent entrance to prevent free-flying mosquitoes from entering the tent, a BG-Sentinel trap (Bio-Gents AG, Regensburg, Germany) was placed on the central platform described above in each tent. The trap was baited with CO₂ and a BG-Lure (a human odor mimic consisting of lactic acid, fatty acids, and ammonia). The CO₂ was delivered near the trap entrance with PVC tubing connected to a 9-kg compressed gas cylinder utilizing Clarke's (Clarke, St Charles, IL, USA) FLOWSWT1. This consists of a regulator (REG1) with a fixed output of 15 psi, with an in-line flow restrictor (ORIF7) and a 10 Micron filter (FILT1) which provides a steady CO₂ flow of 500 ml/min. The BG-Lure, effective for 5 months, was placed in the designated hole in the trap's lid.

### Meteorological Conditions—

During the period of study, ambient weather conditions which included temperature, humidity, and wind speed were recorded every 30 seconds continuously for each 24-hout period of testing using a Kestrel 4500 NV pocket weather tracker (Boothwyn, Pennsylvania, USA).

### Study Initiation and Completion—

This study was conducted once a week in for 4 weeks from 8 to 29 Jun. 2021. After the TF-activated CRPDs were suspended at the entrance of the treated tent to begin the study they remained in place until the end of 4th study increment. No additional TF was used. Weekly study increments were designed to evaluate the efficacy of the TF-activated CRPDs over time. To begin the study, bioassay cages with mosquitoes were suspended from the 15 selected stations inside the treated tent and the 5 selected stations inside the control tent. The TF-activated CRPDs were suspended at the entrance of the treated tent and knockdown timing began. The numbers of mosquitoes knocked down in the bioassay cages were recorded every 15 minutes for the first hour, and then at 2, 4, and 24 hours post-exposure. After the 4-hour knockdown count the BG-Sentinel trap in each tent was switched on and the free-flying mosquitoes were released from the north end of both screened enclosures. Each study increment was terminated after the 24-hour knockdown count and mosquitoes captured in the BG-Sentinel traps were collected and stored in a freezer to be counted and identified to species.

### Statistical Analysis—

All statistical analyses were performed using R v 4.0.3. Tidyverse package v. 1.3.1, and R stats package v 4.0.3. An array of 45 bioassay cages (n=25 mosquitoes per bioassay cage) from the treated tent were used in this analysis. The data were modeled in a way to show knockdown rates over 7 time points up to 24 hours.

For analysis, groups of bioassay cages were blocked from the front to the rear of the tent and from the left to the right following the schematic shown in FIG. 2. This allowed for the analysis of knockdown counts laterally in the tent, and from the entrance to the rear over time. Analysis was also performed without the blocks to show knockdown counts over time using the entire tent. These data did not pass testing for normality and were unable to be transformed to fit a normal curve. A non-parametric Kruskal-Wallis model was used to compare knockdown rates vs time and location. Dunn's multiple comparison was used for post-hoc testing for any significant results from the Kruskal-Wallis test.

Knockdown counts in the array of 5 bioassay cages hung in the control tent were conducted in parallel during each replication of the study. The controls were limited to cover the length and width of the tent to determine if any other environmental factors were responsible for mosquito mortalities or knockdowns. Placement of a full array of 45 bioassay cages in the control tent was not necessary because little or no knockdown of controls was observed in preliminary studies.

This example discloses thee materials and methods used to determine the spatial repellency of pyrethroids azeotrope-like mixtures in CRPDs to repel, knock-down, and/or kill arthropod pests.

### Example 2

### Use of Azeotrope-Like Mixtures in CRPDS

The effects of the Transfluthrin (TF) controlled release passive devices to Ae. aegypti mosquitoes in bioassay cages were studied.

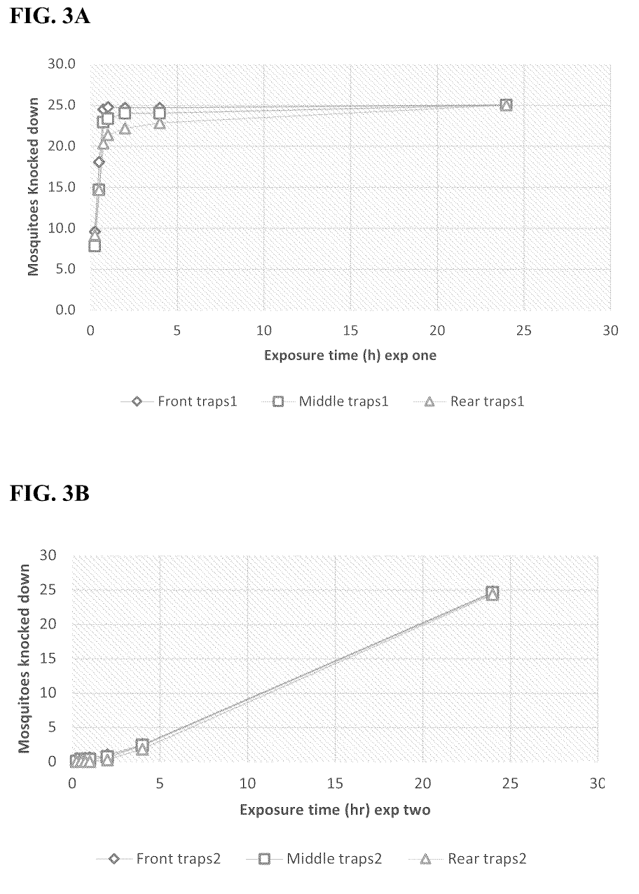

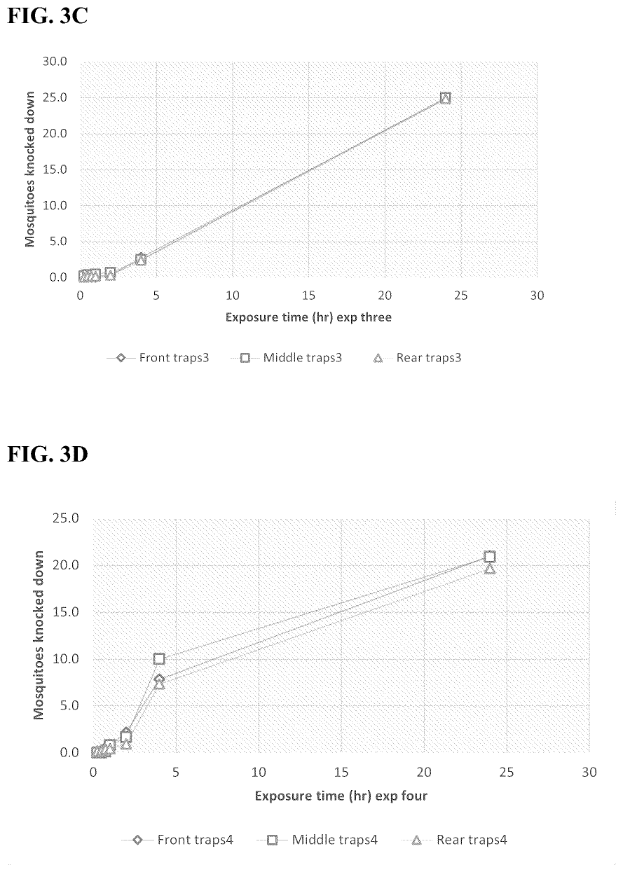

As seen in FIG. 3A to FIG. 3D, the effects of the TF-activated CRPDs to Ae. aegypti mosquitoes in bioassay cages were similar during the entire 4-week study. The exception was day 1 of increment 1 where it appeared that TF was released in greater-than-expected amounts from the recently activated CRPDs. This first increment had significantly different knockdown counts over time when comparing with the 2nd, 3rd, and 4th iterations (Dunn's multiple comparison test, P<0.001). There was an 80 to 100% knockdown of mosquitoes in all bioassay cages in the treated tent when the 1-hour counts were recorded in increment 1. In increment 4 there was an unexpected rapid increase in knockdown between the 2-hour and 4-hour counts that was not as pronounced for increments 2 and 3.

For the first and second increments, the knockdown counts were significantly higher in the blocks of traps at the front of the tent than in the rear (χ2=19.94, df=2, P<0.001 and χ2=9.23, df=2, P<0.001, respectively). There were no front to rear significant differences in knockdown counts in the third and fourth increments, and no significant differences left blocks and right blocks in any of the increments 1 to 4. Between the 4 hour and 24 hour counts knockdown increased throughout the treated tent to essentially 100% in all bioassay cages in all 4 increments. Because of the experimental design, i.e. the long interval between the 4 hour and the 24 hour counts, the actual times required to reach the knockdown/morality levels counted at 24 hours (usually close to 100%) remain unknown.

Knocked down mosquitoes sometimes regained flight and were not counted as knocked down in subsequent observations. Thus, some knockdown/mortality values recorded later in time from the same bioassay cages were slightly lower than earlier ones. Occasionally mosquitoes regained flight after knockdown occurred, but at the 24 hour count a majority of the knocked down mosquitoes were either dead or incapable of flight. In the control tent there were zero to two knockdowns in all bioassay cages from the start to the completion of each 24-hour study increment.

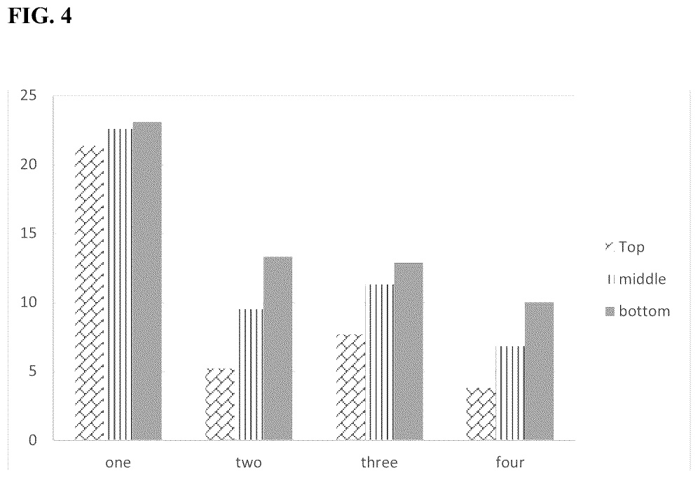

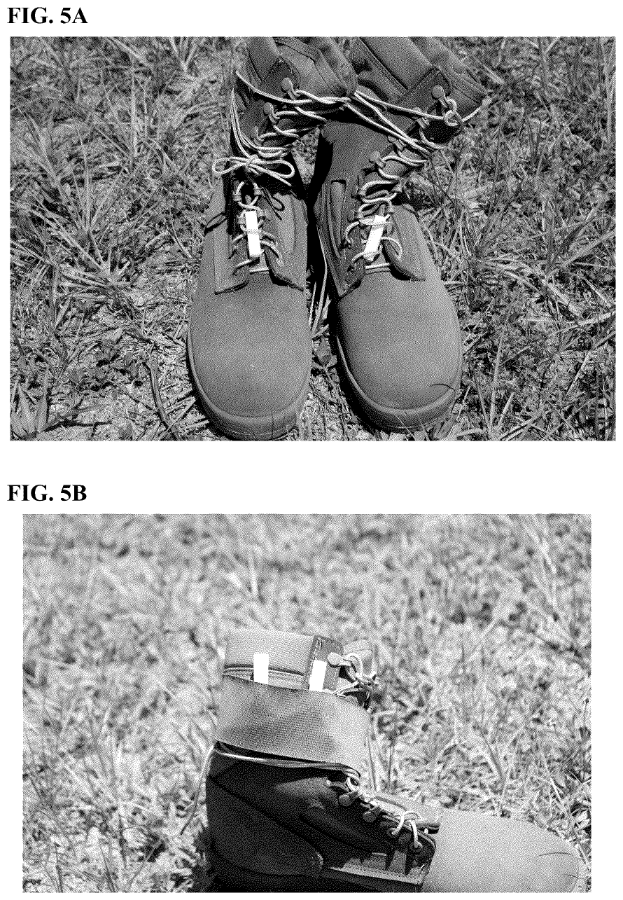

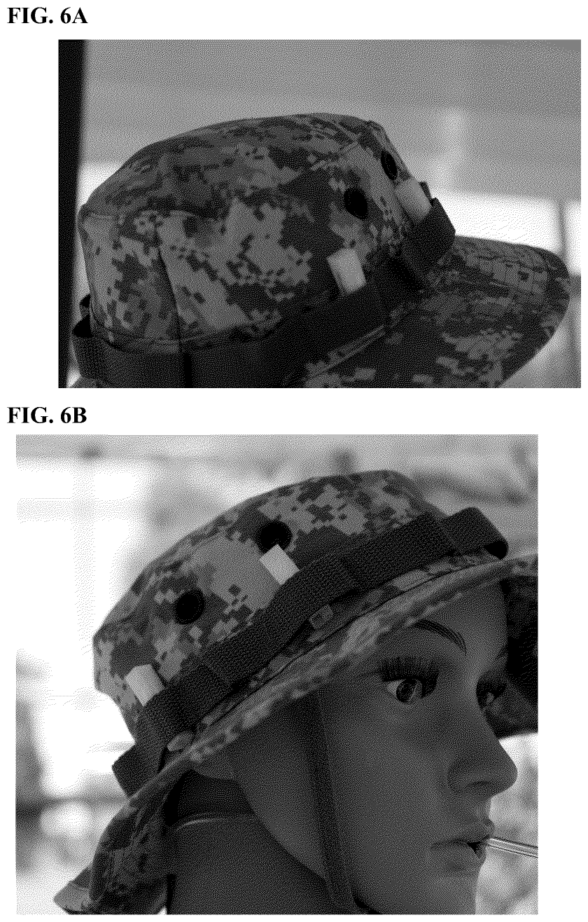

As seen in FIG. 4, knockdown/mortality means in the bioassay cages suspended at three different levels were always in the following order for the four study increments: bottom cages >middle cages >top cages. In study increment 1 there were no differences in knockdown/mortality means due to cage height. In the study increments 2 to 4, the bottom bioassay cages had significantly greater knockdown means than the top cages (Z=5.051875, P<0.0001), and the middle cages (Z=2.230515, P=0.0257). The middle cages had significantly greater knockdown means than the top cages (Z=2.821360, P=0.0096).

Mean recapture counts of free-flying mosquitoes released after the 4 hour knockdown count and recaptured after the 24 hour count were significantly lower for all species in the treated tent compared with those in the control tent (F_{(1.18)}=753.37, P<0.001). There were no significant differences in recapture means of free-flying mosquitoes among increment dates (F_{(3.18)}=0.698, P=0.565).

Mean recapture counts of free-flying mosquitoes in the treated tent were not significantly different among the mosquito species. Percentages recaptured were: 14.7% (Ae. aegypti); 6.89% (An. quadrimaculatus); 5.22% (Cx. quinquefasciatus); and 1.67% (Ae. taeniorhynchus). These percentages are based on the mean recaptures of 300 of each species released on all 3 increment dates (in the first study increment only 300 Ae. aegypti were released).

Mean recapture counts of free-flying mosquitoes in the control tent were significantly different among species (F_{(3.18)}=39.84, P<0.001). Aedes taeniorhynchus recaptures were significantly lower than the other 3 species (Tukey's HSD test, P<0.001). The average control tent recapture rates for study increments 2 to 4 were: 79.2% (An. Quadrimaculatus); 77.4% (Ae. Aegypti); 75.2% (Cx. quinquefasciatus); and 42.7% (Ae. taeniorhynchus).

There were some expected statistical differences in temperature and humidity across study dates, but there was no significant correlation (Kendall's rank correlation tau) between knockdown counts and temperature (Z=0.82527, P=0.4092, tau=0.0171) or humidity (Z=0.79125, P=0.4288, tau=0.0170).

The results obtained in this example show that a pyrethroid azeotrope-like mixture is capable of repelling, knocking-down, and/or killing arthropod pests when used in the CRPDs described herein, in an efficient and active manner.

We claim:

1. A spatial repellent azeotrope-like mixture comprising a pyrethroid.

2. The spatial repellent azeotrope-like mixture of claim 1, wherein the pyrethroid is allethrin, bioallethrin, bioresmethrin, cyfluthrin, cypermethrin, cyphenothrin, d-phenothrin, deltamethrin, fenvalerate, fluvalinate, metofluthrin, permethrin, phenothrin, resmethrin, tefluthrin, tetramethrin, transfluthrin, or a mixture thereof.

3. The spatial repellent azeotrope-like mixture of claim 2, wherein the pyrethroid is Transfluthrin

4. The spatial repellent azeotrope-like mixture of claim 1, wherein the azeotrope-like mixture comprises benzyl alcohol, dimethylsulphoxide, ethyl acetate, butyl acetate, ethyl L-acetate, propylene carbonate, dowanol pm, cyclohexane, petroleum oil, or a mixture thereof.

5. The spatial repellent azeotrope-like mixture of claim 1, wherein the azeotrope-like mixture comprises benzyl alcohol.

6. A controlled release passive device (CRPD) containing at least one spatial repellent azeotrope-like mixture comprising a pyrethroid to repel, knock-down, and/or kill arthropod pests.

7. The CRPD of claim 6, wherein the spatial repellent azeotrope-like mixture is present in an absorbent material.

8. The CRPD of claim 7, wherein the absorbent material is from plant source, animal source, or a combination thereof.

9. The CRPD of claim 8, wherein the absorbent material is from cotton, ramie, linen, or a mixture thereof.

10. The CRPD of claim 8, wherein the absorbent material is from silk, wool, or a mixture thereof.

11. The CRPD of claim 6, wherein spatial release of the azeotrope-like mixture does not require heat, movement, or an electrical stimulus.

12. A method for repelling, knocking-down, and/or killing arthropod pests, the method comprising exposing said arthropod pests to at least one CRPD containing at least one fiber web impregnated with at least one spatial repellent azeotrope-like mixture.

13. The method of claim 12, wherein the at least one CRPD is fastened to a surface or a subject.

14. The method of claim 13, wherein the subject is a human, a pet, or a horse.

15. The method of claim 14, wherein the subject is a human and the at least one CRPD is fastened to a shoe, a shoelace, a hat, or an article of clothing.

16. The method of claim 14, wherein the subject is a horse and the at least one CRPD is fastened to a horse hood, socks, or leggings.

17. The method of claim 14, wherein the subject is a dog and the at least one CRPD is fastened to a leash, a harness, or a collar.
